(19) United States
(12) Patent Application Publication
(10) Pub. No.: US 2009/0048904 A1
(43) Pub. Date: Feb. 19, 2009

(54) METHOD AND SYSTEM FOR DETERMINING TOPICAL ON-LINE INFLUENCE OF AN ENTITY

(76) Inventors: Christopher Daniel Newton, Douglas (CA); Marcel Albert Lebrun, Fredericton (CA); Christopher Bennett Ramsey, Fredericton (CA)

Correspondence Address: VICTORIA DONNELLY, PO BOX 24001, HAZELDEAN RPO, KANATA, ON, K2M 2C3, CA

(21) Appl. No.: 12/174,345

(22) Filed: Jul. 16, 2008

Related U.S. Application Data
(60) Provisional application No. 60/956,258, filed on Aug. 16, 2007.

(51) Int. Cl. G06Q 30/00; G06Q 99/00

(52) U.S. Cl. 705/10; 705/1

(57) ABSTRACT

A method and system for determining topical on-line influence of an entity are disclosed. An influence value of one social media outlet, such as a blog or social networking site, is calculated based on viral properties extracted from publications or posts by the entity through the social media outlet. When the entity has a number of social media outlets associated with it, the topical on-line influence value of the entity is determined based on the influence value of each of the associated social media outlets.

### RELATED APPLICATIONS

The present invention claims benefit from the U.S. provisional application Ser. No. 60/956,258 to Newton, Christopher et al. filed on Aug. 16, 2007 entitled “Method and System For Determining Topical On-line Influence of an Entity”, which is incorporated herein be reference.

### FIELD OF INVENTION

The present patent application relates to a computer implemented method and system for determining influence in social media, and in particular, to a computer implemented method and system for determining a topical on-line influence of an entity.

### BACKGROUND OF THE INVENTION

Determining on-line influence of a commentor, an individual or an entity, in social media sites becomes an increasingly important subject nowadays. A major problem facing marketers and public relations (PR) professionals revolves around the prolific use of social media sites and the awesome scale they have achieved. Literally hundreds of thousands of videos, blog posts, podcasts, events, and social network interactions, such as wall posts, group postings, and others, occur daily. Due to the sheer volume of content, constantly changing landscape of popular sites, and hundreds of millions of users involved, it is impossible to determine who should be listened to and those who must be engaged.

Existing systems for determining influence in social media are site based, i.e. their models of influence are calculated on a per-site basis. If there is a one-to-one relationship from a site to a person (an author), then the influence is extrapolated to indicate the person's influence for the medium in which the site exists. For instance, if siteA is a blog with only one author, and all blogs are counted similarly, then the influence for the siteA as calculated by the prior art methods would also indicate the influence for the author of the blog.

Prior art methods predominantly calculate influence in social media by recursively analyzing inbound web page link counts. For example, siteA would have a higher influence score then siteB if the following approximate rules apply:

RULE 1. If siteA has more links pointing at it, then siteB has linking to it.

RULE 2. If the sites pointing at siteA have a higher count of sites pointing at them, then the count of sites that are pointing at the sites that point at siteB.

Rule 2 is applied recursively.

Various issues exist with the prior art methods, namely:
The methods assume the total influence of the sites can be measured by a single property and that no other factors affect influence to a scale large enough to invalidate using only inbound link count as the measured property;
The methods assume that the picture painted by the link graph is complete enough to be a proxy for influence;
The methods assume that a link implies that the linker has been influenced by the site he is linking to, which is not necessarily the case;
The methods do not account for connections someone may have with a site, if there is no link to track that connection, i.e. if a visitor does not own a blog, and therefore does not link out to anyone, but he is still a frequent visitor to the blog, e.g., http://www.autoblog.com, then the influence that Autoblog has over the visitor is not calculated; and
The methods do not map properly to other types of content and methods of social media expression, e.g., link-analysis methods deployed to the blogosphere are not relevant in the micromedia sphere of Twitter, i.e. link analysis techniques do not translate to all forms of social media and therefore they leave out entire pools of influencers that use other media channels as their voice.

US Published patent application 2007/0214097 to Parsons et al. and entitled “SOCIAL ANALYTICS SYSTEM AND METHOD FOR ANALYZING CONVERSATIONS IN SOCIAL MEDIA” discloses a conversation monitoring and analysis method to identify influencers. This prior art publication monitors an on going conversation in social media and extract properties of documents for the conversation such as page popularity, site popularity, relevance, recency, and others. The influence is then computed for all the documents and corresponding publishers, whereby the most influential publishers are being identified.

However, this prior art method uses a limited number of parameters to determining the influence of a publisher, which therefore affects the accuracy of the influence score.

Accordingly, there is a need in the industry for developing alternative and improved methods and system for determining on-line influence of entities publishing content in social media outlets or sites as well as for determining the influence of social media outlets hosting the content.

### SUMMARY OF THE INVENTION

There is an object of the invention to provide an improved method and system for determining topical on-line influence of an entity, which would avoid or mitigate the above mentioned drawbacks.

According to the embodiments of the invention, a topical on-line influence is introduced, which is a measure of how many people are engaged in a message of an entity (an individual, an organization, or a company) around a given topic. UserA has a higher influence around topicA then userB if postings by the userA that match topicA garner more influence metrics, quicker and higher in total count, then the userB.

The topical on-line influence is first defined for each form of content or social media outlet by using a first influence model taking into account weighted viral properties for the form of content, and then calculating across various forms of content by using a second influence model, which takes into account weighted topical influences for different forms of content.

A user is allowed to manipulate the first and second influence models by adding additional viral properties to equations used in the models, or removing certain viral properties from the equations, and by adjusting weights in the equations.

According to one aspect of the invention, there is provided a method for determining topical on-line influence of an entity, comprising the steps of:
(a) matching and tagging content, published by the entity through a social media outlet, with a selected topic;
(b) extracting one or more viral properties from the tagged content;
(c) determining topical on-line influence of the social media outlet according to a first influence model by taking into account the extracted viral properties; and
(d) determining topical on-line influence of the entity according to a second influence model by taking into account the topical on-line influence for one or more social media outlets associated with said entity.

Beneficially, the step (b) comprises:
collecting values of the viral properties for each tagged content; and
aggregating the collected values across the tagged content.

The step (b) further comprises:

collecting values of the viral properties at predetermined time intervals; and

storing the collected values in respective time series.

Conveniently, the viral properties are selected from the group consisting of: user engagement value; average comment count; average unique commentor count; cited individual count, inbound links; subscribers; average social bookmarks; average social news votes; buries; total count of posts; and total count of appearance of Individuals names across all posts.

The step (c) comprises defining the first influence model as a linear combination of the extracted one or more viral properties weighted with respective weights associated with each of the extracted viral properties.

The step (d) comprises defining the second viral properties as a linear combination of the topical on-line influence of the social media outlets weighted with respective weights associated with each of the social media outlets.

Conveniently, the step (a) comprises selecting the social media outlet from the group consisting of: a social networking outlet; a blog outlet; a video streaming outlet; an image sharing outlet; a podcast outlet; a web analytics outlet; a peer-to-peer torrent outlet; a live stream outlet; a main stream outlet; and a social news outlet.

In the method described above, the entity is selected for the group consisting of: an individual; an organization; and a corporation.

The method further comprises identifying top influencers, whose topical on-line influence value is above a predetermined threshold, and displaying the results on a computer screen.

The method of further comprises identifying top movers among entities, comprising determining a speed of change of the topical on-line influence values for the entities, and displaying the results on a computer screen.

According to another aspect of the invention, there is provided a method for determining a topical on-line influence, comprising steps of:
(a) defining an entity;
(b) selecting a topic;
(c) selecting a social medial outlet associated with said entity;
(d) retrieving pieces of content posted by said entity from the social media outlet, which match the selected topic;
(e) extracting viral properties of the retrieved pieces of content; and
(f) determining topical on-line influence of the social media outlet based on the extracted viral properties; and
(h) determining a topical on-line influence model of the entity based on the topical on-line influence for one or more social media outlets associated with said entity.

Advantageously, the step (e) further comprises collecting values of viral properties for each piece of content and aggregating them across all pieces of content.

In the embodiment of the invention, the step (f) comprises determining a linear combination of the extracted viral properties weighted with respective weights associated with each of the extracted viral properties.

The step (h) comprises determining a linear combination of the topical on-line influence of the social media outlets weighted with respective weights associated with each of the social media outlets.

Conveniently, said one or more social media outlets are selected from the group consisting of a social networking outlet, a blog outlet, a video streaming outlet, an image sharing outlet, a podcast outlet, a web analytics outlet, a peer-to-peer torrent outlet, a live stream outlet, a main stream outlet, and a social news outlet.

According to yet one more aspect of the invention, there is provided a system for determining a topical on-line influence of an entity, comprising:

a computer, having a microprocessor and a computer readable medium, storing computer readable instructions, for execution by the processor, to form the following:
(a) a matching module for matching and tagging content to a selected topic said content published by said entity through a social media outlet;
(b) a viral properties extraction module for extracting viral properties from the tagged content;
(c) an outlet influence modeling module for calculating a topical on-line influence for the social media outlet according to an influence model by taking into account the extracted viral properties; and
(d) an entity influence modeling module for calculating the topical on-line influence of the entity according to an influence model by taking into account the topical influence for one or more social media outlets associated to said entity;

the microprocessor processing operations of said matching module, said viral protection extraction module, said outlet influence modeling module and said entity influence modeling module.

The viral properties extraction module comprises a means for collecting values of the viral properties at predetermined time intervals and storing the collected values in respective time series.

The system further comprises a user interface module for defining the entity, associating the social media outlets with the entity, and assigning weights for each of said viral properties and for each of said social media outlets.

The user interface module further comprises means for graphically displaying results of the calculation of the topical on-line influence for the entity.

A computer readable medium is also provided, comprising a computer code instructions stored thereon, which, when executed by a computer, perform the steps of the method described above.

Thus, the embodiments of the present invention provide a computer implemented method and system for automatically calculating the influence of an entity by recording various social media engagement/influence metrics over time and processing the recorded metrics, e.g., by applying a sequence of weighted equations.

### BRIEF DESCRIPTION OF THE DRAWINGS

Embodiments of the invention will now be described, by way of example, with reference to the accompanying drawings in which:

FIG. 1A illustrates a system architecture, in which the embodiments of the present invention have been implemented;

FIG. 1B illustrates different social media outlets that can be used with the present invention;

FIG. 2 illustrates a Content-to-Topic Matching block 150 of the system of FIG. 1;

FIG. 3 shows a flowchart 300 illustrating the operation of the Content-to-Topic Matching block of FIG. 2;

FIG. 4A shows a block diagram for a system for determining a topical on-line influence of an entity according to the embodiment of the invention;

FIG. 4B illustrates viral properties for various social media outlets;

FIG. 5 shows a flowchart illustrating the operation of the system of FIG. 4;

FIG. 6 illustrates a user interface for adjusting the weights in the influence calculation model;

FIG. 7 illustrates a user interface representation of calculated influence measures for origin sites around a given topic; and

FIG. 8 illustrates a user interface showing top movers and top influencers for a given topic.

### DETAILED DESCRIPTION OF THE EMBODIMENTS OF THE INVENTION

Embodiments of the invention describe influence measurement models for determining the influence in social media, in particular, for determining a topical on-line influence of an entity.

The measurements are topically relevant, and can be cross channel aggregated, i.e. aggregated across various forms of content or social media outlets or sites.

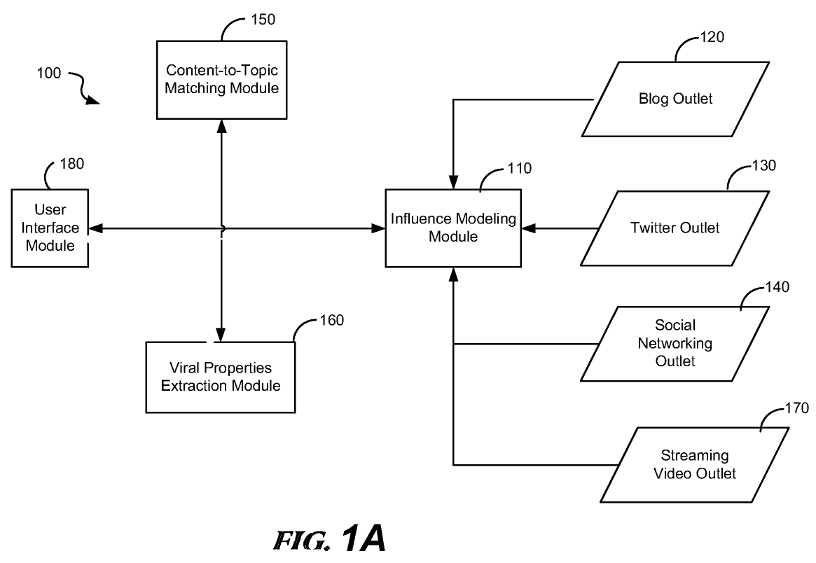

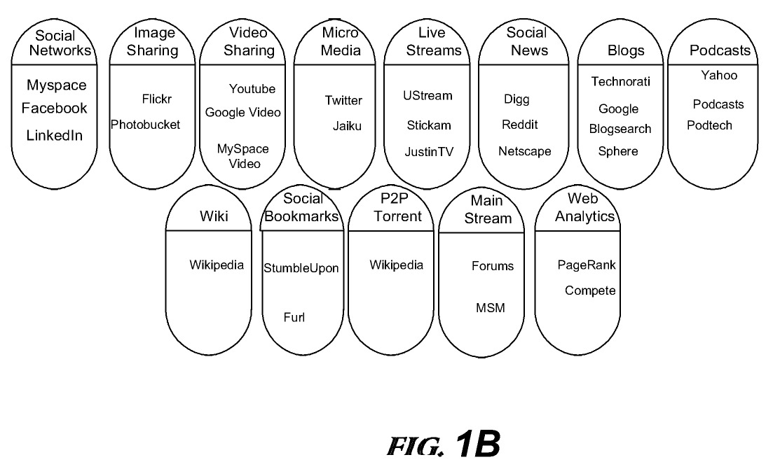

FIG. 1 illustrates a system architecture for implementing the embodiments of the present invention. As shown in FIG. 1, the system 100 comprises a processor and a computer readable medium having instructions stored thereon, for execution by the processor, to form the modules of the system 100 as will be described below. The system 100 comprises a Content-to-Topic Matching Module 150 for generating tagged content, which is connected to a Viral Properties Extraction Module 160 for extracting viral properties from the tagged content. The Influence Modeling Module 110 processes the tagged content and the viral properties, and generates a topical on-line influence model of a social media outlet 120, 130, 140, 170 associated with an entity. The Influence Modeling Module 110 generates also a topical on-line influence model of an entity combining all the topical on-line influences of the social media outlets associated with the entity. A social media outlet in this instance is a form or type of content such as a blog, a micromedia-based content, a video channel content, a user profile page, or a social networking-based content. As shown in FIG. 1, a blog outlet 120, a twitter outlet 130, a social networking outlet 140 and a streaming video outlet 170 are connected to the Influence Modeling Module 110. In this instance, the Influence Modeling Module 110 generates a topical on-line influence model for each of the social media outlet as well as a topical on-line influence model for the entity associated with the social media outlets 120, 130, 140, 170 shown in FIG. 1.

FIG. 1B of the present application shows another exemplary list of social media outlets that can be used in the embodiments of the present invention.

As mentioned above, the system 100 illustrated in FIG. 1 is implemented in one or more software modules, comprising computer readable instructions stored in a computer readable medium of a computer, for example, a general purpose or specialized computer, having a central processing unit (CPU), and a memory and other storage devices such as CD, DVD, hard disk drive, etc. As an example, modules of the system 100 can be implemented as individual software modules running on the same hardware platform. Alternatively, modules of the system 100 can be implemented on different hardware platforms, e.g., on different computers connected in a network. Other implementations are possible and are well known to the persons skilled in the art.

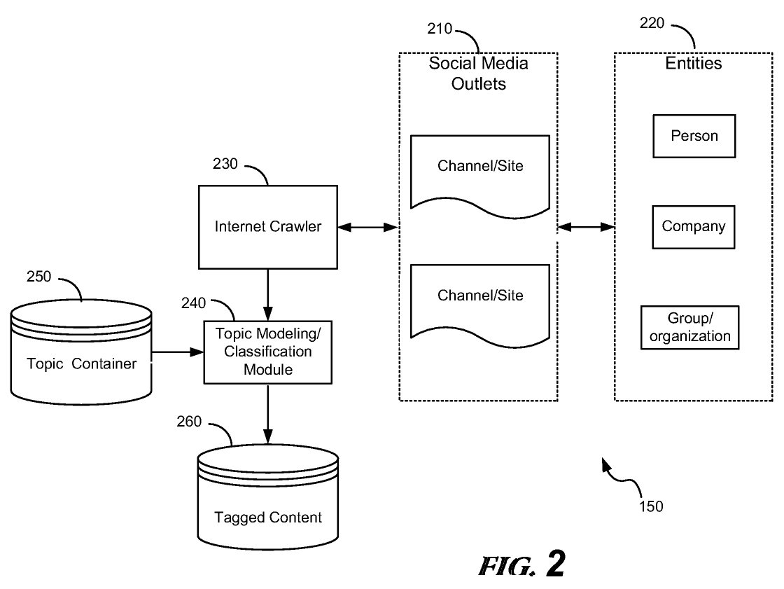

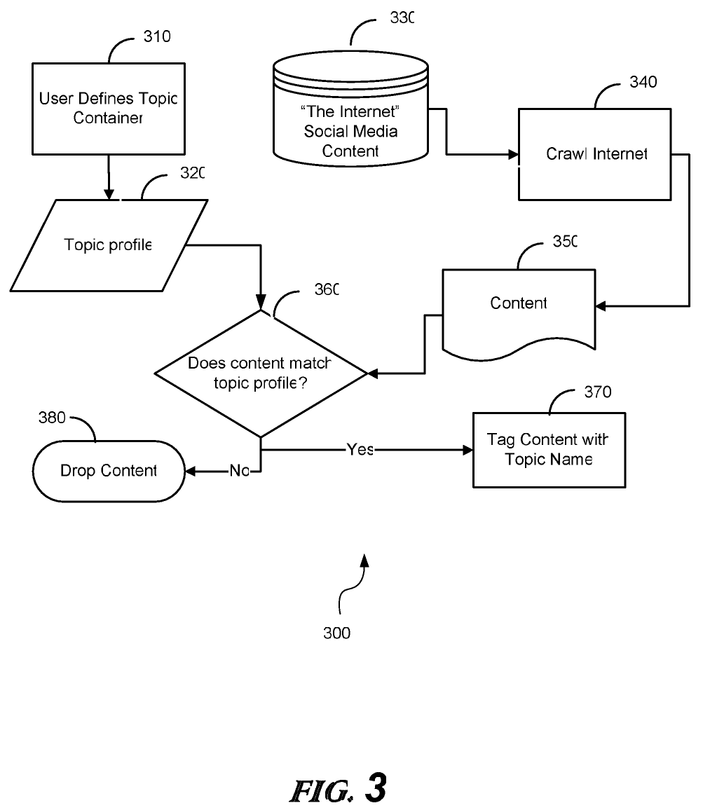

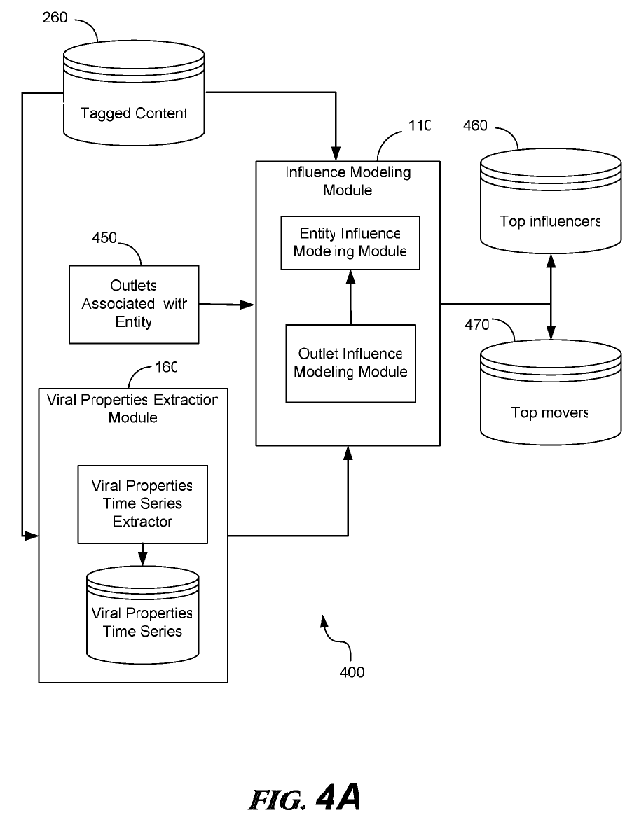

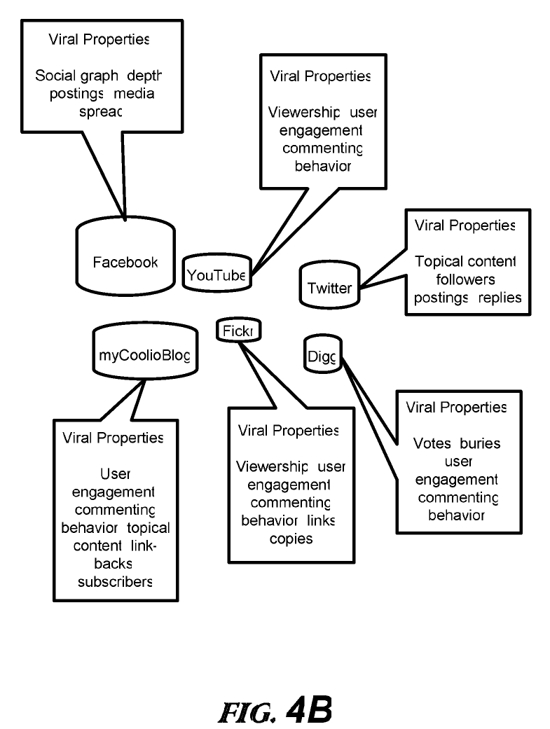

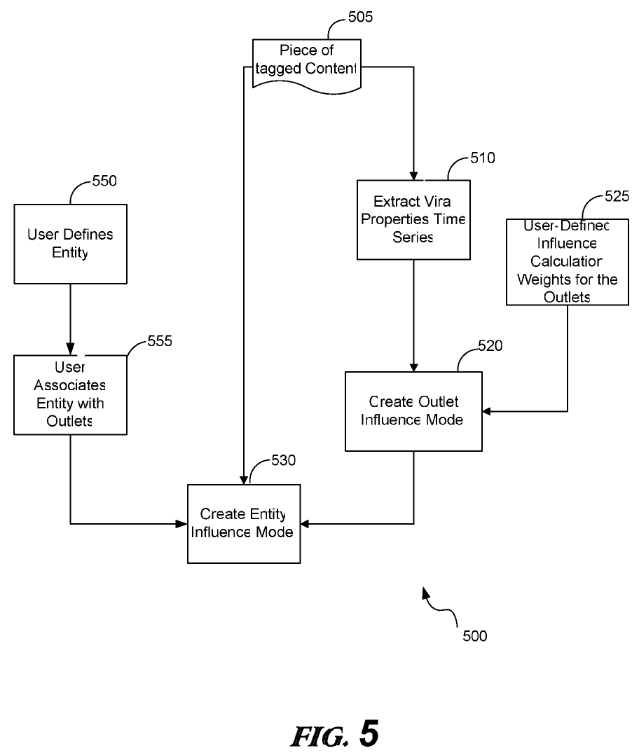

The Content-to-Topic Matching Module 150 of the system 100 matches accessed content with user-defined topics to produce tagged content. The architecture and operation of this module will be described with reference to FIG. 2 and FIG. 3 below. The Viral Properties Extraction Module 160 extracts viral properties from tagged content by collecting the viral properties at predetermined time intervals and storing them in a time-series format. The Content-to-Topic Matching Module 150 will be described with reference to FIG. 4 and FIG. 5 below.

A user interface module 180 is also provided to allow a user to interact with the system 100. The user interface module 180 comprises a computer readable code stored in a computer readable medium, which, when executed, provides a graphical user interface (GUI), or a command-line interface, to allow a user to interact with the system 100. For example, the GUI provided by the user interface module 180 can be used for setting a schedule for collecting values of the viral properties.

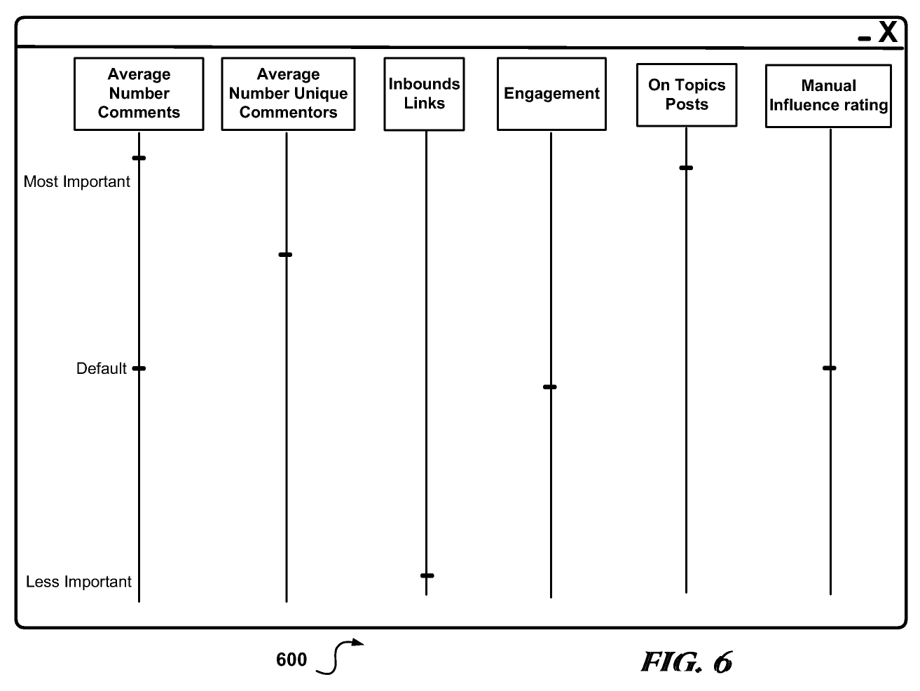

Additionally, and will be shown with regard to FIG. 6 below, a user can setup or modify weights associated with various viral properties or with social media outlets, which are used in the determination on the influence models through a view 600 of a graphical interface provided by the user interface module 180. As shown in FIG. 6, the user can set the values of the weights which reflect their level of importance in the determination on the influence models.

FIG. 2 illustrates the Content-to-Topic Matching Module 150 of the system 100 in more detail. The diagram 150 shows entities 220 such as an individual, a company, or a named group or organization, which may have one or more channels/sites collectively referred to as social media outlets 210 where they publish some form of content. The social media outlets 210 are accessible to an Internet Crawler 230 which is connected to a Topic Modeling/Classification Module 240. The Topic Modeling/Classification Module 240 is also connected to a Topic Container 250, from which it receives topic-related information. The Topic Modeling/Classification Module 240 processes the topic-related information and content retrieved by the Internet crawler 230 to match the content to a defined topic. The matched content is then stored in a tagged content database 260.

The Topic Container 250 is a collection of words, phrases, and necessary Boolean logic that describes a subset of all possible social media content, usually centered around a brand, name, field of study, market, concept, or product.

The Topic Modeling/Classification Module 240 defines a topic model, which is a trained text classification model, created by feeding, to a text classifier, a labeled corpus of on-topic and not on-topic content. The classifier can then gauge unlabelled data based on how closely it matches the trained topic model. Text or content classification methods are well known and any of those methods can be used to classify and tag the content.

The operation of the Content-to-Topic Matching Module 150 will now be described in more detail with reference to a diagram 300 of FIG. 3. At step 310, a user defines, through the interface of the user interface module 180 of FIG. 1, a topic container such as “Social Media” encapsulating a topic profile 320 against which retrieved content need to be matched. For example, the topic profile 320 may include terms such as ‘blogging’, ‘social media’, ‘social networking’, and ‘video sharing’ and others which describe the topic container “Social Media”.

At step 340, social media content 330 are identified by crawling the Internet and the discovered social media content 350 are presented to an analysis phase. All discovered social media content 350 are passed through the analysis phase at step 360 where the content is matched against the topic profile 320. If the content does not match the topic, it is disregarded (step 380). If a match is found, the content is then tagged with the corresponding term in the topic profile (step 370).

FIG. 4A shows a block diagram for a system for determining a topical on-line influence of an entity according to the embodiment of the invention. The Tagged Content 260 is provided in connection with the Viral Properties Extraction Module 160. The tagged content 260 as described above is a content that matches a selected topic profile and identifies the channel/site hosting the content.

Viral Properties Extraction Module 160, through its Viral Properties Time Series Extractor 430, extracts the viral properties related to the tagged content 260 and stores them in time series in the viral properties database 435 so that the history of each viral property is recorded. Viral properties, also referred to as influence metrics, are defined as the various social media popularity metrics. Examples of viral properties include but are not limited to:
User engagement across topically relevant posts, wherein the engagement is measured by the length of the commenting threads and the number of unique commentors;
Average Comment count across topically relevant posts;
Average unique commentor count across topically relevant posts;
Cited individual count,
Inbound links across topically relevant posts;
Blog subscribers across all posts;
Average Social bookmarks across all topically relevant posts;
Average Social news votes and buries across all topically relevant posts;
Total Count of topically relevant posts; and
Total Count of appearance of Individuals names across all posts.

Other influence metrics include breadth of reply, views, bookmarks, votes, buries, favorites, awards, acceleration, momentum, subscription counts, replies, spoofs, ratings, friends, followers, posts, and updates.

FIG. 4B shows some specific viral properties that are extracted for various forms of content, and their weights are set accordingly as illustrated in FIG. 6.

An Outlet Influence Modeling Module 440 receives viral properties from to the Viral Properties Time Series Extractor 430 and computes the influence of every single social media outlet associated with the entity. In computing the influence of a social media outlet, the Outlet Influence Modeling Module 440 receives also user-defined influence weights for each collected viral properties of a social media outlet and applies a first influence model involving the weights of the viral properties of all the tagged content posted or published by the entity through the social media outlet.

An Entity Influence Modeling Module 410 creates a topical on-line influence model of the entity based on the respective topical influence of the social media outlets associated with the entity (module 450) and calculated by the Outlet Influence Modeling n Module 440.

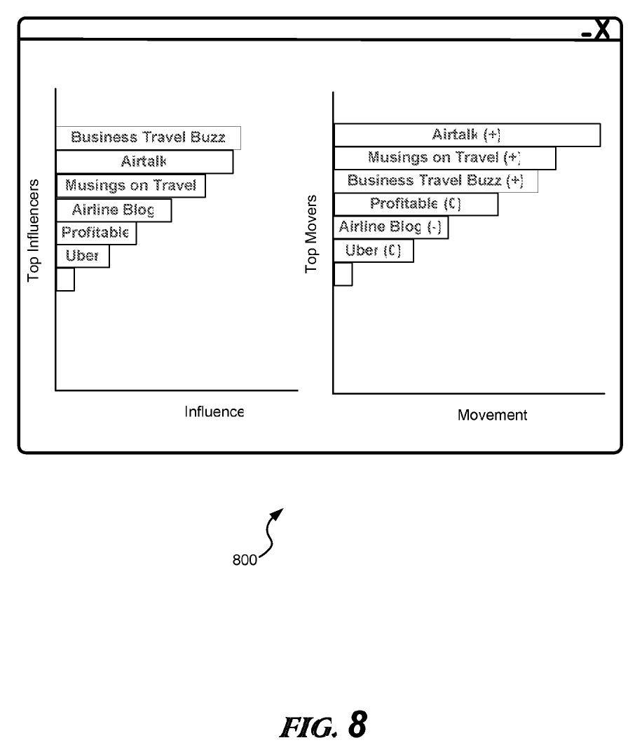

The Entity Influence Modeling Module 410 also generates a listing of top influencers 460 based on the influence value of the entities. This listing identifies most influential entities in a given topic. Additionally, the Entity Influence Modeling Module 410 also generates a listing of top movers 470 for a given topic. The listing of top movers 470 is representative of entities having rapidly-changing influence values. A graphic representation of top influencers and top movers on a GUI provided by the user interface module 180 is shown in FIG. 8 and will be described hereinafter.

FIG. 5 illustrates a flowchart 500 describing an operation of the influence modeling module 110 shown in FIG. 1. FIG. 5 will now be described by considering an example involving an imaginary user named Robert Scoble, who is a heavy user of social media technologies, and very influential on the topic of social networking, and blogging. In the embodiment of the present invention, Robert Scoble is an entity. He generates a lot of media, through a number of different social media outlets. Robert is a prolific blogger, Twitter user (which is a micromedia technology), Facebook user (Social Networking), and streaming video user (Kyte.tv). These are Robert's 4 primary social media outlets, and his audience is the collective audience across the 4 social media outlets. His influence in each social media outlet is specific to the social media outlet itself, and relative to others. For example, Robert is very influential and heavily read blogger, to whom many others are compared, but his Kyte.tv streaming video channel may look pale in comparison to channels by other authors on Kyte.tv.

As illustrated in the flowchart 500, each piece of content 505 that matches the topic container 250 is scheduled to have its viral properties extracted at step 510 on a regular schedule, and stored in time series so that the history of each viral property is recorded. Each piece of content 505 has a social media outlet (e.g. site, channel for video streaming, or user profile page) where it has originated. For blogs, a blog post is a piece of content, and the blog site is the originating site. For a recorded streaming video, the origin is the user's channel on the streaming video provider's site. For a Tweet (a posting on Twitter), the origin is the user's profile page.

The schedule used for time extracting of the viral properties changes as the recorded viral property values are analyzed. For instance, if upon checking the viral properties for a blog post on a 3 hour schedule, it is determined that the number of new comments has exploded, then the schedule will be altered to ensure that the viral properties are checked more frequently. Conversely, if the comment count has changed little or not at all, the schedule may be changed to check with half the frequency, down to every 6 hours. Conveniently, different viral properties may have same or different time extraction schedule.

The extracted viral properties are used at “Create Outlet Influence Model”, step 520 to determine the influence of each of the social media outlets based on the viral properties collected from each of the pieces of content 505 and following a first influence model. Following up on the example above, the influence model for determining the influence of the blog associated with Robert Scoble can be expressed as a linear combination of viral properties such as in the following equation:

CalculatedBlogInfluence=(Weight1*BlogEngagement)+(Weight2*Average comment Count)+(Weight3*Average Unique Commentor Count)+(Weight4*Inbound Links)+(Weight5*Blog Subscribers)+(Weight6*Bookmarks)+(Weight7*Votes)+(Weight8*Count of Topically relevant posts),

where Weight1-Weight8 are respective weight factors defining the relevant contribution of various viral properties into the topical influence value for this blog, and the topical influence value is conveniently normalized to a scale of 0-100. The weight for each type of social media outlet is also user-defined and is entered at “User-Defined Influence Calculation Weights for the outlets” step 525.

In the embodiment of the present invention, a user is responsible for adjusting the weights for the above noted equation to reflect the viral properties that, in the user's opinion, are most telling of the business goals he or his clients have set forth. The user's adjusted weights are saved on a per topic basis, allowing for a different topic to have a different weighting system to align with potentially different business goals.

The user adjusts the weights from the user interface 180 illustrated in FIG. 1 and sets their value according to their level of importance as shown in FIG. 6 described above.

As with blogs, viral properties are extracted for each piece of topically relevant media published by Robert Scoble through his video streaming outlet on Kyte.tv. The viral property values are stored in a time series and used in determining the influence for the video streaming outlet. The equation for determining the influence is as follows:

CalculatedVideoChannelInfluence=(Weight11*Average Concurrent Viewership)+(Weight12*Total Views)+(Weight13*Inbound Links)+(Weight14*Engagement)+(Weight15*Average Comment Count)+(Weight16*Unique Commentor Count)+(Weight17*Count of Topically Relevant Posts)

where Weight11-Weight17 are respective weight factors defining the relevant contribution of various viral properties into the topical influence value of this form of content, and the topical Influence value is conveniently normalized to a scale of 0-100.

Assuming that similar work has been done to find Robert Scoble's Twitter presence, and his Facebook profile, to calculate respective MicroMediaInfluence and SocialNetworkInfluence for these two social media outlets using viral properties specific to the two forms of content (as illustrated in FIG. 4B) and other additional viral properties in a manner already described above with regard to the calculations of the CalculatedBlogInfluence and CalculatedVideoChannelInfluence. Thus, there are now four separate social media outlets, on which Robert Scoble has established followers and exerts some level of influence.

To connect the four social media outlets within the system, a new entity profile, of type ‘person’, and name it ‘Robert Scoble’ is created at step 550. As described above, entities can have different types such as Person/individual, Organization, or Company. The user then associates, at step 555, the Robert Scoble blog site, the Robert Scoble Kyte.tv channel, Robert Scoble's Twitter profile, and his Facebook account to the entity profile ‘Robert Scoble’.

At “Create Entity Influence Model”, step 530, an entity influence model is created based on a weighted aggregation of the topical on-line influences of all the social media outlets associated with Robert Scoble.

All defined entities have user weighted influence quation to calculate the topical online influence across various social media outlets. Because entities may wield more influence in one form of content then another, the weights can be applied on a per-entity basis, e.g., the user may adjust the weights on Robert Scoble's Influence equation to one set of values that are different from the weights they apply to other entities in the system. In the absence of a user defined custom set of weights for an entity's influence, the system default influence equation weights will be used for that entity type. All entity types will have a default set of weights defined in the system that will be used in absence of user defined weights.

An exemplary linear equation for determining a topical on-line influence of the entity “Robert Scoble” is as follows:

EntityInfluence=((Weight111*CalculatedBlogInfluence)+(Weight222*CalculatedVideoChannelInfluence)+(Weight333*CalculatedMicroMediaInfluence)+(Weight444*CalculatedSocialNetworkInfluence))/4.

where Weight111-Weight444 are respective weight factors defining the relevant contribution of various forms of content in to the final entity influence value.

The resulting value of the topical on-line influence of the entity is in the range of 0-100 and represents an influence score for the entity that takes into account two layers of user defined expert knowledge via the weighting model at the social media outlet layer (e.g. the weights on the viral properties used in the determination of the influence score for a blog) and across various social media outlets (the weights on each social media outlet relative to each other).

The example described above considers 4 social media outlets associated with Robert Scobble. Additional social media outlets such as Social News, ImageSharing or other listed in FIG. 1B can very well be associated with Robert Scobble. The EntityInfluence can then be expressed in a generic form of a topical on-line influence model integrating all social media outlets associated with the entity as follows:

EntityInfluence=((Weight1*outlet_{—}1_Influence)+(Weight2*outlet_{—}2_Influence)+ . . . +(Weightn*outlet_n_Influence))/n

where Weight1-Weightn are respective weight factors defining the relevant contribution of various social media outlets (outlet_1 -outlet_n) in to the final entity influence value. Other formulas based on linear or non-linear functions could also be used to model the topical on-line influence of the social media outlets or the topical on-line influence of the entity.

As stated above and shown in FIG. 1, a user interface module 180 is included in the present invention to provide an interface (e.g. GUI) for interacting with the system 100.

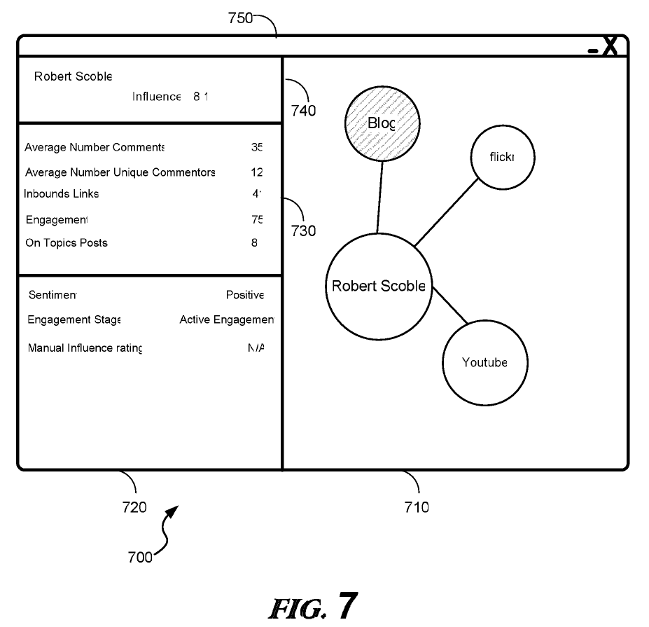

FIG. 7 shows an exemplary view 700 representing one form of the GUI. Section 710 of the view 700 shows the network of social media outlets associated with the entity Robert Scoble. Section 750 shows some menu options such as “close” and “minimize” (X and _ respectively). Section 740 shows the influence score of the entity while section 730 shows the individual values of the viral properties collected for a selected social media outlet (in this instance the blog outlet 120).

Section 720 of FIG. 7 shows user defined parameters that can be adjusted or included in the influence models. As an example, the user may add new properties to the equation. For instance, the user may decide to include a manual sentiment score in the range of 0 to 100, with 0 being neutral included in the calculations for blog sites, but not for any of the other social media outlets. The user can go to a configuration panel (not shown) and edit the equation for CalculatedBlogInfluence, adds a new viral property from section 720, defines its range and sets its default weight. After performing such actions, the new CalculatedBlogInfluence equation becomes as follows:

CalculatedBlogInfluence=(Weight1*BlogEngagement)+(Weight2*Average comment Count)+(Weight3*Average Unique Commentor Count)+(Weight4*Inbound Links)+(Weight5*Blog Subscribers)+(Weight6*Bookmarks)+(Weight7* Votes)+(Weight8*Count of Topically relevant posts)+(Weight9*ManualSentimentScore).

FIG. 8 shows a graphical representation of top influencers and top movers for a given topic. As stated above, the Entity Influence Modeling Module 410 can generate a listing of top influencers 460, whose topical on-line influence value is above a predetermined threshold, and a listing of top movers 470, whose speed of change of the topical on-line influence is above a predetermined threshold. These two listings can be represented graphically as shown in FIG. 10 with an indication of the movement of the influence values among the top movers. As shown in FIG. 10 influence values of the entities may have positive (+) movement, negative (−) movement or neutral (0) movement. The movement can be calculated from a rate of change of the influence value over a period of time. For example if an Entity A has an influence value that changes from 8 to 13 within a fixed period T, its rate of change would be 5/T. Entities having the highest rate of change in absolute value will be included in the listing of top movers 470.

A computer readable medium is also provided, e.g., CR-ROM, DVD, floppy, or a computer memory, having computer executable instructions stored thereon for execution by a processor to perform the steps of the methods described above.

The present invention provided numerous advantages, most importantly, public relation professionals to make preemptive marketing decisions that are not available today.

Thus, improved methods and system for determining topical on-line influence of an entity have been provided.

Although the embodiment of the invention has been described in detail, it will be apparent to one skilled in the art that variations and modifications to the embodiment may be made within the scope of the following claims.

What is claimed is:

1. A method for determining topical on-line influence of an entity, comprising the steps of:
(a) matching and tagging content, published by the entity through a social media outlet, with a selected topic;
(b) extracting one or more viral properties from the tagged content;
(c) determining topical on-line influence of the social media outlet according to a first influence model by taking into account the extracted viral properties; and
(d) determining topical on-line influence of the entity according to a second influence model by taking into account the topical on-line influence for one or more social media outlets associated with said entity.

2. The method as described in claim 1, wherein the step (b) comprises:
collecting values of the viral properties for each tagged content; and
aggregating the collected values across the tagged content.

3. The method as described in claim 1, wherein the step (b) comprises:
collecting values of the viral properties at predetermined time intervals; and
storing the collected values in respective time series.

4. The method of claim 1, wherein said viral properties are selected from the group consisting of:
user engagement value;
average comment count;
average unique commentor count;
cited individual count,
inbound links;
subscribers;
average social bookmarks;
average social news votes;
buries;
total count of posts; and
total count of appearance of Individuals names across all posts.

5. The method of claim 1, wherein the step (c) comprises defining the first influence model as a linear combination of the extracted one or more viral properties weighted with respective weights associated with each of the extracted viral properties.

6. The method of claim 1, wherein the step (d) comprises defining the second viral properties as a linear combination of the topical on-line influence of the social media outlets weighted with respective weights associated with each of the social media outlets.

7. The method as described in claim 1 wherein the step (a) comprises selecting the social media outlet from the group consisting of:
a social networking outlet;
a blog outlet;
a video streaming outlet;
an image sharing outlet;
a podcast outlet;
a web analytics outlet;
a peer-to-peer torrent outlet;
a live stream outlet;
a main stream outlet; and
a social news outlet.

8. The method of claim 1, wherein the entity is selected for the group consisting of:
an individual;
an organization; and
a corporation.

9. The method of claim 1, further comprising identifying top influencers, whose topical on-line influence value is above a predetermined threshold, and displaying the results on a computer screen.

10. The method of claim 1 further comprising identifying top movers among entities, comprising determining a speed of change of the topical on-line influence values for the entities, and displaying the results on a computer screen.

11. A method for determining a topical on-line influence, comprising steps of:
(a) defining an entity;
(b) selecting a topic;
(c) selecting a social medial outlet associated with said entity;
(d) retrieving pieces of content posted by said entity from the social media outlet, which match the selected topic;
(e) extracting viral properties of the retrieved pieces of content; and
(f) determining topical on-line influence of the social media outlet based on the extracted viral properties; and
(h) determining a topical on-line influence model of the entity based on the topical on-line influence for one or more social media outlets associated with said entity.

12. The method of claim 11, wherein the step (e) further comprises collecting values of viral properties for each piece of content and aggregating them across all pieces of content.

13. The method of claim 12, wherein the step (f) comprises determining a linear combination of the extracted viral properties weighted with respective weights associated with each of the extracted viral properties.

14. The method of claim 13, wherein the step (h) comprises determining a linear combination of the topical on-line influence of the social media outlets weighted with respective weights associated with each of the social media outlets.

15. The method of claim 11, wherein said one or more social media outlets are selected from the group consisting of a social networking outlet, a blog outlet, a video streaming outlet, an image sharing outlet, a podcast outlet, a web analytics outlet, a peer-to-peer torrent outlet, a live stream outlet, a main stream outlet, and a social news outlet.

16. A system for determining a topical on-line influence of an entity, comprising:
a computer, having a processor and a computer readable medium, storing computer readable instructions, for execution by the processor, to form the following:
(a) a matching module for matching and tagging content to a selected topic said content published by said entity through a social media outlet;
(b) a viral properties extraction module for extracting viral properties from the tagged content;
(c) an outlet influence modeling module for calculating a topical on-line influence for the social media outlet according to an influence model by taking into account the extracted viral properties; and
(d) an entity influence modeling module for calculating the topical on-line influence of the entity according to an influence model by taking into account the topical influence for one or more social media outlets associated to said entity;
the processor processing operations of said matching module, said viral protection extraction module, said outlet influence modeling module and said entity influence modeling module.

17. The system as described in claim 16, wherein the viral protection extraction module comprises a means for collecting values of the viral properties at predetermined time intervals and storing the collected values in respective time series.

18. The system as described in claim 16, further comprising a user interface module for defining the entity, associating the social media outlets with the entity, and assigning weights for each of said viral properties and for each of said social media outlets.

19. The user interface module of claim 19 further comprising means for graphically displaying results of the calculation of the topical on-line influence for the entity.

20. A computer readable medium, comprising a computer code instructions stored thereon, which, when executed by a computer, perform the steps of the method of claim 1.
